(19) United States
(12) Patent Application Publication
(10) Pub. No.: US 2024/0259913 A1
(43) Pub. Date: Aug. 1, 2024

(54) RFL BACKHAUL HANDLING WITH DUAL CONNECTIVITY

(71) Applicant: Fraunhofer-Gesellschaft zur Förderung der angewandten Forschung e.V., München (DE)

(72) Inventors: Thomas HAUSTEIN, Berlin (DE); Thomas WIRTH, Berlin (DE); Jasmina MCMENAMY, Berlin (DE)

(21) Appl. No.: 18/635,882

(22) Filed: Apr. 15, 2024

Related U.S. Application Data
(63) Continuation of application No. PCT/EP2022/078652, filed on Oct. 14, 2022.

(30) Foreign Application Priority Data
Oct. 15, 2021 (EP) 21203042.3

(51) Int. Cl. H04W 40/24; H04W 28/02; H04W 40/12

(52) U.S. Cl. CPC H04W 40/248; H04W 28/0289; H04W 40/12

(57) ABSTRACT

A method for operating a wireless communication network has: using multi connectivity of an IAB node to establish, with the IAB node, a first link for a first path to a network node of the wireless communication network and a second link for a second path to a network node of the wireless communication network; routing a data traffic of the IAB node via the first path; and re-routing at least a part of the data traffic over the second path in case of a past, present or expected change of a link characteristic of a link of a path of the wireless communication network.

### CROSS-REFERENCE TO RELATED APPLICATIONS

This application is a continuation of copending International Application No. PCT/EP2022/078652, filed Oct. 13, 2022, which is incorporated herein by reference in its entirety, and additionally claims priority from European Application No. 21203042.3, filed Oct. 15, 2021, which is also incorporated herein by reference in its entirety.

### TECHNICAL FIELD

Embodiments of the present application relate to the field of wireless communication, and more specifically, to wireless communication between a user equipment and a base station. Some embodiments relate to radio link failure, RLF, backhaul handling with dual connectivity, DC.

### BACKGROUND OF THE INVENTION

FIGS. 1A-1B are schematic representation of an example of a terrestrial wireless network 100 including, as is shown in FIG. 1A, a core network 102 and one or more radio access networks RAN1, RAN2, . . . RANN. FIG. 1B is a schematic representation of an example of a radio access network RANn that may include one or more base stations gNB1 to gNB5, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANn may include more or less such cells, and RANn may also include only one base station. FIG. 1B shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1B shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1B by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1B by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

For a wireless communication system as described above, New Radio, NR, Release 16 has seen the introduction of Integrated Access and Backhaul, IAB, architecture to enable flexible and dense deployment of NR cells. IAB supports self-backhauling, which eases the requirement for densifying the underlying transport network. IAB architecture also enables multi-hop communication, which can address some of the challenges associated with mmWave propagation, enabling thus the use of large swaths of mmWave spectrum.

IAB nodes are designed to facilitate a new type of base station architecture with a split/disaggregated protocol stack between a distributed unit (DU) with lower layers of the protocol stack and a central unit (CU) with centralized higher layer protocol functions. Thus, the IAB nodes house a DU, and a UE-like mobile termination part (MT). The MT-part is responsible for transmission and reception to/from the upstream nodes in the IAB topology as well as for connection to the CU. The nodes that provide both—DU and CU functionality are referred to as IAB donors. In other words, IAB-donor-CU is the gNB-CU of an IAB-donor, terminating the F1 interface towards IAB-nodes and IAB-donor-DU (TS 38.401 V16.6).

For said wireless communication networks, there is the need of providing reliable communication.

It is noted that the information in the above section is only for enhancing the understanding of the background of the invention and therefore it may contain information that does not form prior art and is already known to a person of ordinary skill in the art.

### SUMMARY

According to an embodiment, a method for operating a wireless communication network may have the steps of: using multi connectivity of an IAB or relay node to establish, with the IAB or relay node, a first link for a first path to a network node of the wireless communication network and a second link for a second path to a network node of the wireless communication network; routing a data traffic of the IAB or relay node via the first path; measuring a link characteristic by one or more of:
data rate/throughput,
packet delay or jitter,
packet loss
level of RSSI, RSRP, SNR, SINR, PMI, rank (RI) of the link measured at the IAB or relay node,
level carrier frequency offset (CFO) is above a predefined threshold, or synchronization loss,
occurrence/probability/observation of radio link failure (RLF),
value or result of cost function or costs
amount/number of newly available links in the wireless communication network; and
   re-routing at least a part of the data traffic over the second path in case of a past, present or expected change of the link characteristic of a link of a path of the wireless communication network.

Another embodiment may have an IAB or relay node, configured for operating a wireless communication network, the IAB or relay node having a wireless interface and configured for: using multi connectivity of an IAB or relay node to establish, with the IAB or relay node, a first link for a first path to a network node of the wireless communication network and a second link for a second path to a network node of the wireless communication network; routing a data traffic of the IAB or relay node via the first path; and re-routing at least a part of the data traffic over the second path in case of a past, present or expected change of a link characteristic of a link of a path of the wireless communication network.

Another embodiment may have a network node configured for operating in a wireless communication network, the network node having a wireless interface and being configured for: detecting a change of a link characteristic of an IAB-link of a path of the wireless communication network; and informing another node of the wireless communication network about the change.

### BRIEF DESCRIPTION OF THE DRAWINGS

Embodiments of the present invention are described herein making reference to the appended drawings, in which:

FIGS. 1A-1B show schematic representations of an example of a wireless communication system;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 is a schematic representation of a wireless communication system comprising a transceiver, like a base station or a relay, and a plurality of communication devices, like UEs, according to an embodiment;

FIG. 7 shows a schematic block diagram of a known Dual connectivity aspect IAB network;

FIGS. 8A-B show schematic block diagrams representing at least a part of wireless communication network that may be addressed by embodiments described herein;

FIGS. 9A-B show schematic representations of a wireless communication network performing a congestion-triggered path switch to route traffic according to embodiments;

FIGS. 10A-B show schematic representations of a wireless communication network performing a congestion-triggered path switch within an IAB node to route traffic according to embodiments;

FIG. 11 shows a schematic flow chart of a method for transmitting failure information according to an embodiment;

FIGS. 12A-B show schematic representations of a wireless communication network according to an embodiment performing a provision of additional links;

FIG. 13 shows a schematic block diagram of a wireless communication network according to an embodiment in which IAB nodes establish a D2D connection between them to bypass a congestion;

FIGS. 14A-C show schematic block diagrams of wireless communication networks according to embodiments in which a UE and/or a repeater operates with an IAB node;

FIG. 15 shows a schematic flow chart of a method according to an embodiment that may be used to operate a wireless communication network and to re-route traffic;

FIG. 16 shows a schematic flow chart of a method according to an embodiment that may be used to operate a wireless communication network and to inform network participants about a change in a link characteristic; and

FIG. 17 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

As already indicated in the introductory portion, reliable communication is an aim in wireless communication networks. Dealing with events such as radio link failure (RLF) and congestion in a multi-hop backhaul network might cause severe issues at devices and networks. Furthermore, IAB nodes are expected to be deployed in a higher frequency range, e.g., FR2 or mmWave spectrum, where sudden blockages occur. These events may cause loss of service, delays, degradation in throughput, or in general a degradation of any particular KPI.

For the dual-connected IAB-nodes there is at least a partial path diversity, which should be used to mitigate such events.

Release 16 while supporting the transfer of MCG and SCG failure messages in the backhaul network, falls short of utilising to a greater extent this path diversity for the cases of congestion mitigation, RLF recovery, reduction of delays, increasing the capacity, and better provision of QoS in general.

### Congestion Handling for Single Connected IAB Node

Downlink: Release 16 introduces a few mechanisms to deal with the congestion on the backhaul, BH, links. These are specified for UL and DL separately, and some of the specified mechanisms are E2E or hop-by-hop mechanisms. For example, on the DL, E2E flow control uses as a basis the DL Data Delivery Status (DDDS) specified for split CU/DU architecture (TS 38.425, v16.3). DDDS in an IAB network reports access node DU information to the donor CU. Aspects such as the desired buffer size per DRB, desired data rate per DRB, the highest successfully delivered packet data convergence protocol (PDCP) SN etc. are reported to the IAB-donor. As per DL hop-by-hop mechanisms, in Rel-16, an IAB node generates a flow control message. The message is formed when its buffer load exceeds a certain level or when it receives a flow control polling message from a peer BAP entity, e.g., a parent node. Flow control information provides the available buffer size and can be at the granularity of BH RLC channels or destination routing ID. Possible actions triggered by the reception of the flow control message and the configurations/values of thresholds and other parameters to trigger flow control message (e.g., buffer threshold values, polling timers, etc.) are not specified and are left to IAB/network implementation [R2-2108493].

Uplink: The UL scheduling is considered baseline for hop-by-hop flow control. Hence, in Release 16, only hop-by-hop flow control is supported by using preemptive Buffer Status Report (BSR). Pre-emptive BSR is triggered based on UL grants provided to child nodes and/or UEs, or based on BSRs from child nodes or UEs.

### Radio Link Failure (RLF)-Related

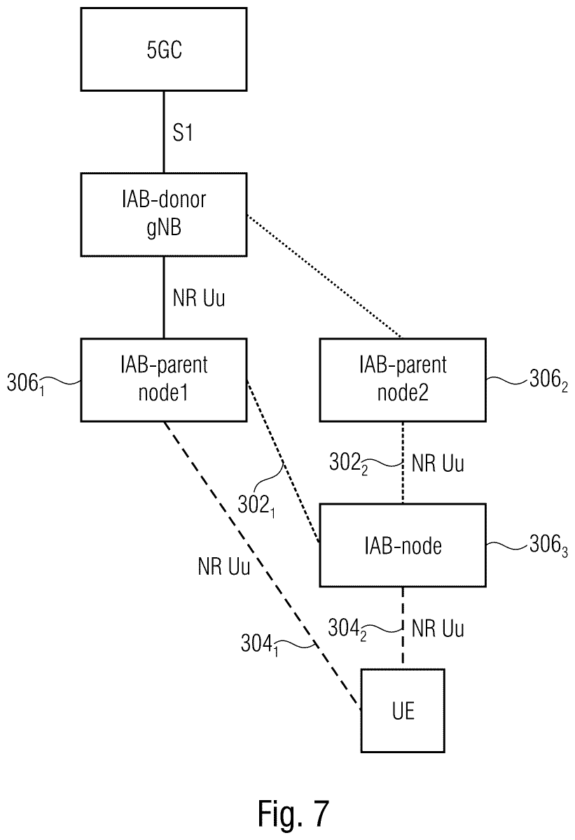

Multi Radio dual connectivity, MR-DC/New Radio Dual-connectivity NR DC framework, which enables a device to connect to two cells, or in general, two cell groups, the Master Cell Group (MCG) and the Secondary Cell Group (SCG) is also used in IAB. Here, the MCG and SCG related procedures by the UE are used as a basis for configuration of dual radio links from IAB node to two parent nodes, as, in principle, the IAB-MT inherits a subset of functionality from the UE. NR-DC with IAB nodes 306₁-306₃ is depicted in FIG. 7—the roles of Master Node, MN, and secondary node, SN, are assigned to the parent nodes serving the outer leaf access IAB node. As may be seen from FIG. 7 that shows a schematic block diagram of a known Dual connectivity aspect IAB network with connections 302₁ and 302₂ of a MT-DC, and connections 304₁ and 304₂ of a UE-DC.

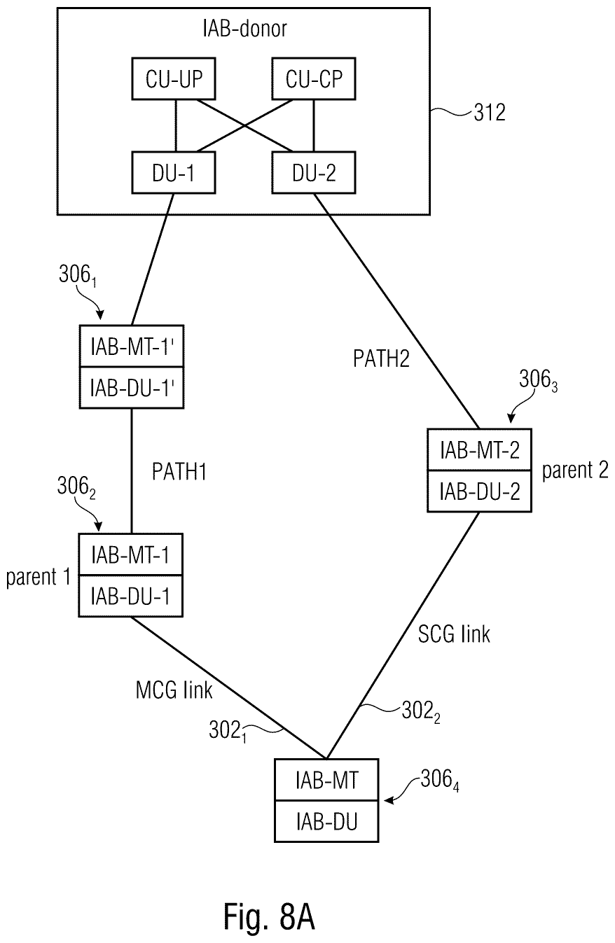

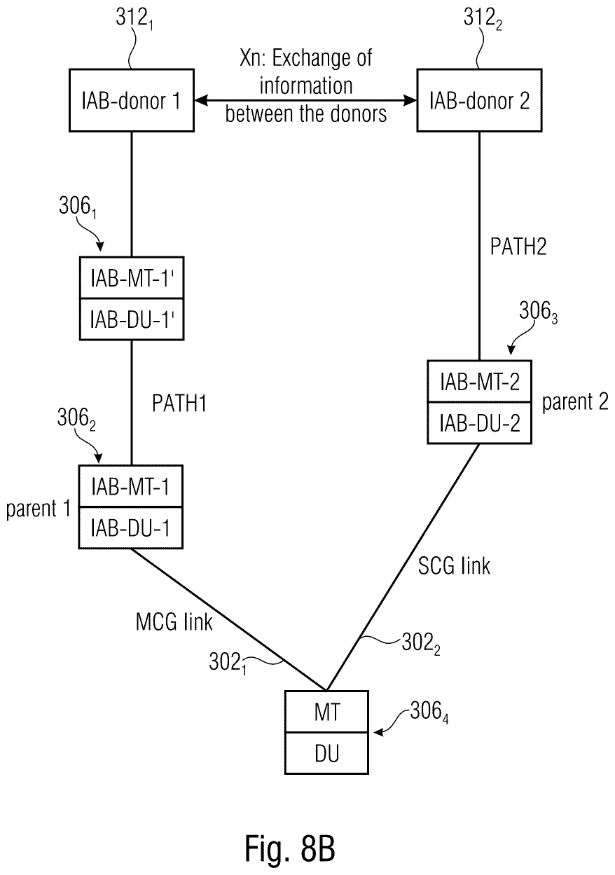

In case of EN-DC (E-UTRA-NR Dual Connectivity), the backhaul traffic can only be routed via the NR interface. FIG. 8A and FIG. 8B depict the backhaul aspects for a dual-connected IAB node with two paths in a scenario with a single donor 312 in FIG. 8A and with two donors 312₁ and 312₂ in FIG. 8B, respectively. That is, in FIG. 8A the dual-connected IAB node 306₄ is under the same donor 312 and the dual-connected IAB node 306₄ is connected to two donors 312₁ and 312₂ in FIG. 8B. Standardization of dual-connectivity for IAB node with two donors has not been finalised.

Of relevance to this scenario addressed by embodiments described herein is SCG failure detection and recovery in MR-DC/NR-DC. It should be noted that in the case of the UE, RLF is declared in a number of situations, such as due to the expiry of a timer indicating radio link problem on the physical layer, due to random access procedure failure, or RLC failure etc. On the other hand, the SCG failure (as declared by the UE) not only relates to RLF, but also to, e.g. SN addition/modification failure. In case of a dual-connected IAB-node, the IAB-MT declares SCG failure in case it receives the BH failure indication from the SCG. This is specified in TS 37.340 v16.7, Section 7.7.

For the purpose of illustration, this scenario refers to a link failure on a (primary) SCG link. According to the IAB 3GPP specifications agreements made in RAN2#107bis), the link failure recovery from an IAB-node towards MN or SN is dealt with separately. In the case of a link failure from an IAB-node towards MN, in Rel-16 the procedures related to link recovery for MCG and SCG are reused in the case of IAB. That is, e.g., MCG or SCG failure report and RRC reestablishment are initiated if “Recovery Failure” notification is received from parent nodes on MCG-link or/and SCG-link (R2-107bis agreement). Also, fast MCG link recovery is supported for MR-DC and EN-DC (R2-109 bis). Here, no RRC re-establishment towards MCG is triggered upon detecting an RLF. Instead, all transmissions from MCG are suspended and MCGFailureInformation message is conveyed to the Master Node, using the link via the Secondary Node. The message contains the reason for the failure and any available measurements at the time of failure. The network, that is the MN then decides on the action, for example, a reconfiguration to change the Primary Cell or if no suitable target cell is determined, the network may send an RRC release message to release the connection.

In case of an SN link failure (SCG RLF), the failure is reported to the MN and the MN decides which further action to take. MN may decide to keep, change, or release the SN/SCG. Further details are described in TS 37.340 V16.7, Section 7.7.

As stated above, an SCG failure can refer to SCG radio link failure, failure of SCG reconfiguration with sync, SCG configuration failure for RRC message on SRB3, SCG integrity check failure, and consistent uplink LBT failures on PSCell for operation with shared spectrum channel access. The content of the SCG failure information element for NR is depicted below (TS 38.331 V16.5.0). The message is sent from a UE to the network.

SCGFailureInformation message

-- ASN1START
-- TAG-SCGFAILUREINFORMATION-START
SCGFailureInformation ::= SEQUENCE {
criticalExtensions CHOICE {

| | |
|---|---|
| scgFailureInformation | SCGFailureInformation-IEs, |
| criticalExtensionsFuture | SEQUENCE { } |

}
}
SCGFailure Information-IEs ::= SEQUENCE {

| | | |
|---|---|---|
| failureReportSCG | FailureReportSCG | OPTIONAL, |

| | |
|---|---|
| nonCriticalExtension | SCGFailureInformation-v1590-IEs OPTIONAL |

}
SCGFailureInformation-v1590-IEs ::= SEQUENCE {

| | | |
|---|---|---|
| lateNonCriticalExtension | OCTET STRING | OPTIONAL, |
| nonCriticalExtension | SEQUENCE { } | OPTIONAL |

}
FailureReportSCG ::= SEQUENCE {

| | |
|---|---|
| failureType | ENUMERATED { |
| | t310-Expiry, randomAccessProblem, |
| | rlc-MaxNumRetx, |
| | synchReconfigFailureSCG, scg-ReconfigFailure, |
| | srb3-IntegrityFailure, other-r16, spare1}, |

| | |
|---|---|
| measResultFreqList MeasResultFreqList | OPTIONAL, |

```
  measResultSCG-Failure OCTET STRING (CONTAINING MeasResultSCG-Failure) OPTIONAL,
  ...,
  [[
```

| | | |
|---|---|---|
| locationInfo-r16 | LocationInfo-r16 | OPTIONAL, |

```
  failureType-v1610 ENUMERATED {scg-lbtFailure-r16, beamFailureRecoveryFailure-r16,
      t312-Expiry-r16, bh-RLF-r16, spare4, spare3, spare2, spare1} OPTIONAL
  ]]
}
MeasResultFreqList ::= SEQUENCE (SIZE (1..maxFreq)) OF MeasResult2NR...,
```

Capacity Measurements within NR

The composite available capacity group specified in TS 38.473 V16.2.0, Section 8.2.10, can be used to report congestion in IAB backhaul networks.

The current report includes the Composite Available Capacity Group Information Element, IE, if the third bit, “Composite Available Capacity Periodic” of the Report Characteristics IE included in the RESOURCE STATUS REQUEST message is set to 1.

If Cell Capacity Class Value IE is included within the Composite Available Capacity Group IE, this IE is used to assign weights to the available capacity indicated in the Capacity Value IE.

If the cell for which Composite Available Capacity Group IE is requested to be reported supports more than one SSB the Composite Available Capacity Group IE for such cell shall include the SSB Area Capacity Value List IE for all SSB areas supported by the cell, providing the SSB area capacity with respect to the Cell Capacity Class Value IE.

If the SSB To Report List IE is included for a cell, the Composite Available Capacity Group IE for such cell shall include the requested SSB Area Capacity Value List IE providing the SSB area capacity with respect to the Cell Capacity Class Value.

Embodiments described herein allow for a stable routing of traffic in a network.

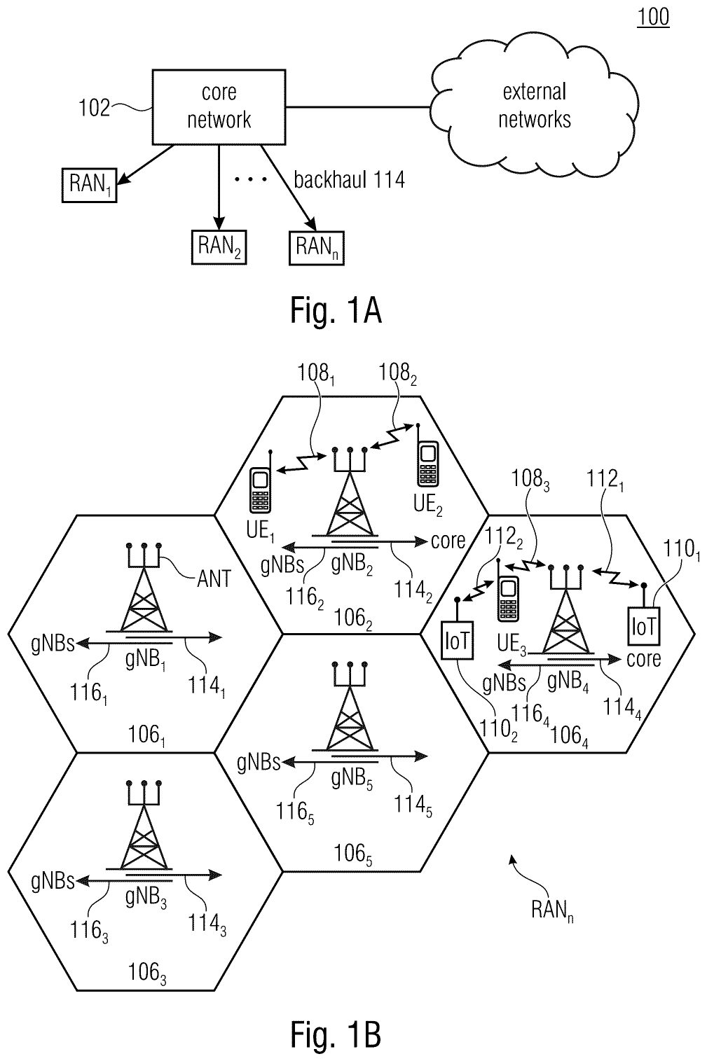

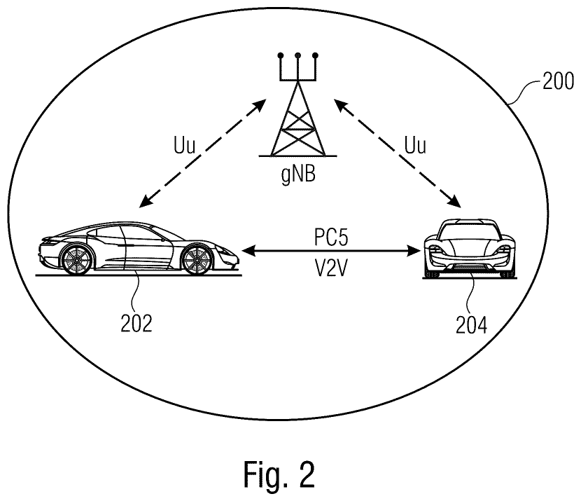

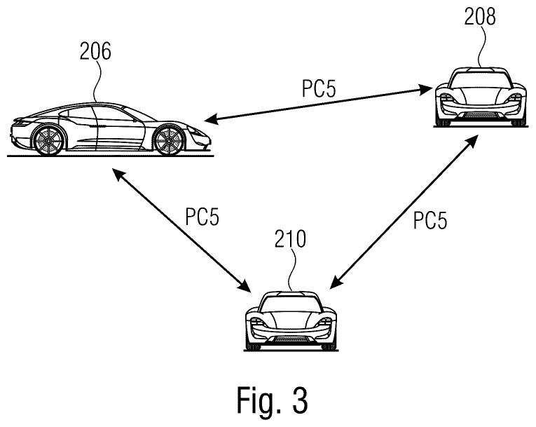

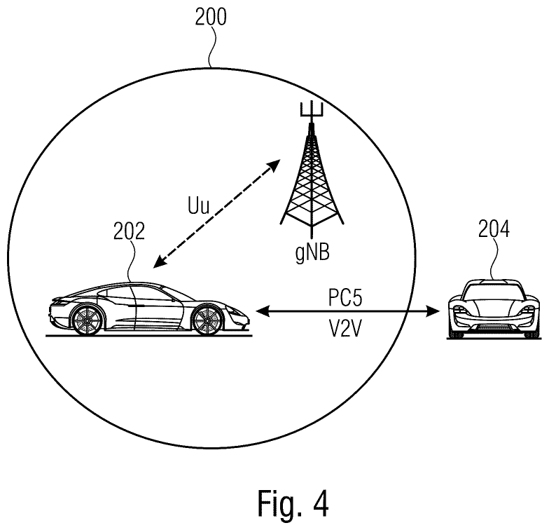

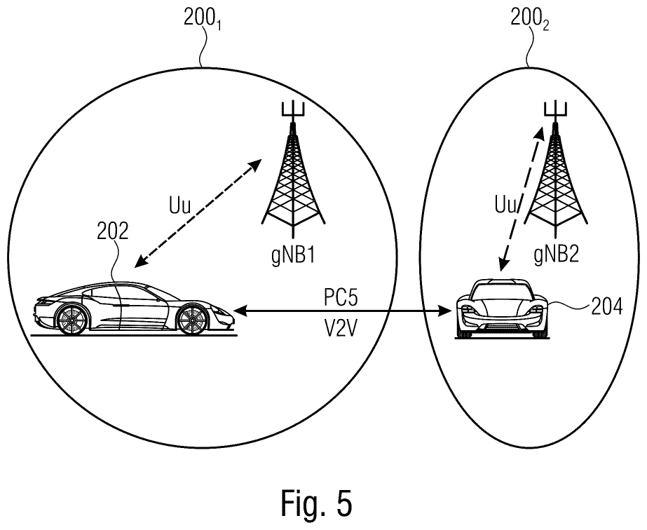

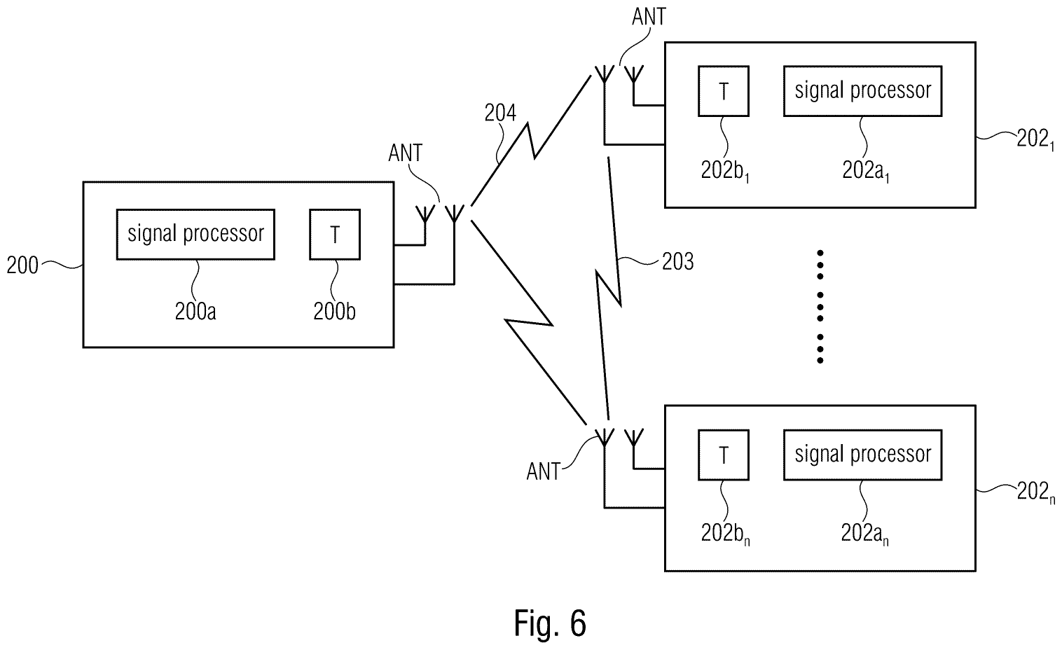

Embodiments of the present invention may be implemented in a wireless communication system or network as depicted in FIGS. 1 to 5 including a transceiver, like a base station, gNB, or relay, and a plurality of communication devices, like user equipment's, UEs. FIG. 6 is a schematic representation of a wireless communication system comprising a transceiver 200, like a base station or a relay, and a plurality of communication devices 2021 to 202n, like UEs. The UEs might communicated directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the uU interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a1 to 202an, and a transceiver (e.g., receiver and/or transmitter) unit 202b1 to 202bn. The base station 200 and/or the one or more UEs 202 may operate in accordance with the inventive teachings described herein.

According to an embodiment, a method for operating a wireless communication network comprises:
using multi connectivity of an IAB node, i.e., a network node, to establish, with the IAB node, a first link for a first path to a network node of the wireless communication network and a second link for a second path to a network node of the wireless communication network;
routing a data traffic of the IAB node via the first path, i.e., to the IAB node and/or from the IAB node; and
re-routing at least a part of the data traffic over the second path in case of a past, present or expected change of a link characteristic of a link of a path of the wireless communication network.

According to an embodiment, the change of the link characteristic relates to at least one of:
a change in a key performance parameter or characteristic of the first path;
an improvement in a path, e.g., the second path or the second link;
a degradation in a path, e.g., the first path or the first link, e.g., a congestion in at least a part of a link to or from the IAB node
a link failure in a path, e.g., the first path;
a newly available link or an alternative path, e.g., to the network node of the first path.

Such a change of link characteristics, in particular to cause degradation of the link quality may also be referred to as a congestion.

According to an embodiment, the first path relates to an aggregation of parallel links between two nodes; or a concatenation of links over multiple hops.

According to an embodiment, the method comprises:
measuring the link characteristic by one or more of:
   data rate/throughput,
   packet delay or jitter,
   packet loss, e.g., by an increase in HARQ NACKs received by a IAB node/DU level of RSSI, RSRP, SNR, SINR, PMI, rank (RI) of the link measured at the IAB node,
   level carrier frequency offset (CFO) is above a predefined threshold, or synchronization loss,
   occurrence/probability/observation of radio link failure (RLF),
   value or result of cost function or costs, e.g., defined as a combination of different KPIs, e.g., delay, throughput, etc.
   amount/number of newly available links in the wireless communication network.

According to an embodiment, the method is implemented, e.g., when referring to the uplink, is implemented such that the routed data traffic is routed from the IAB node via the first path having the first link; and the re-routed data traffic is routed from the IAB node via the different second path having the second link; e.g., and not the first link; or the method is implemented, e.g., when referring to the uplink, such that the routed data traffic is routed to the IAB node via the first path having the first link; and the re-routed data traffic is routed from the IAB node via the different second path or a part of the second path having the second link, e.g., and not the first link.

According to an embodiment, the method comprises: operating the IAB node to locally re-route the part of the data traffic based on a reception of a single, or multiple flow-control indications from a child note, e.g., for a short term congestion.

According to an embodiment, the method comprises:
transmitting a congestion control information from the IAB node or a device, e.g., a user equipment, served by the IAB node to a central unit of the wireless communication network to indicate a persisting congestion;
re-routing the data traffic based on the congestion control information.

According to an embodiment, the re-routing is further based on a routing configuration from a central unit, CU, of the wireless communication network.

According to an embodiment, the method comprises: for an uplink, UL, direction performing local re-routing of a backhaul, BH, traffic being part of the data traffic, based on a number of scheduling requests exceeding a predefined threshold or a buffer status report exceeding a predefined threshold.

According to an embodiment, the method comprises:
selecting the second path based on the first path, the first path having a first number of hops, i.e., between two adjacent nodes a link is established that may define a hop, so as to have a second number of hops, and
the second number of hops increasing the first number of hops by at most a predefined number; or
the second number decreasing the first number by at most a predefined number.

According to an embodiment, the second path is selected to:
Not to exceed/go below a predefined number of hops
Not to exceed/go below a predefined route length/delay/latency
Not to exceed/go below a certain capacity provisioning
Not to exceed certain concatenated outage probability
Not to violate a predefined service level (with certain probability)

According to an embodiment, the second path is selected under consideration of a requested service level, e.g., Quality of Service, QoSof the data traffic;
such that the second path provides for the requested service level at least within a tolerance range.

According to an embodiment, the part of the data traffic is re-routed via the second path; and at least a part of a remaining data traffic is routed via the first path; wherein the second path is selected to provide the requested service level commonly with the first path.

According to an embodiment, re-routing the data traffic comprises to transmit at least a part of the data traffic along the second path.

According to an embodiment, re-routing the data traffic comprises to split a first part from a second part of the data traffic and transmitting the first part of the data traffic over the second link and not the second part.

According to an embodiment, the first part is selected as a part that suffers from the degrading.

According to an embodiment, the first part is at least a part of a control plane related data in the data traffic and the second part comprises at least a part of a user plane related data in the data traffic; or
wherein the first part is at least a part of a user plane related data in the data traffic and the second part is comprises at least a part of a control plane related data in the data traffic.

According to an embodiment, the method comprises:
evaluating a priority of the data traffic, e.g., based on costs or backhaul channel QoS mapping or a backhaul channel ID; and
selecting the first part to comprise a higher priority when compared to the second part.

According to an embodiment, re-routing the data traffic comprises a local or extended routing, e.g., globally at least within the network.

According to an embodiment, the method comprises: triggering, by the IAB node, a (global) re-routing of the data traffic at a central unit, CU, of the wireless communication network.

According to an embodiment, the method comprises: preconfiguring the IAB node to perform local rerouting, e.g., by a central unit, IAB-donor CU, of the wireless communication network.

According to an embodiment, the method comprises: configuring or pre-configuring at least one path node in the second path, e.g., using a central unit, CU, to perform re-routing or to instruct the IAB-node to perform rerouting in case a link of the path node experiences degradation, e.g., congestion or overload, due to the additional load caused by re-routing the data traffic.

According to an embodiment, the method comprises: selecting the second path based on a capacity of links between hops and/or based on a congestion persistence of the links, which nodes along the second path are to perform either branching out based on pre-configured/configured backup routes on the one hand or local re-routing on the other hand.

According to an embodiment, the method comprises: informing the wireless communication network, e.g., a central unit, CU, and/or an IAB donor, about the re-routing.

According to an embodiment, the method comprises: informing the wireless communication network, e.g., a central unit, CU, and/or an IAB donor about the change of the link characteristic; and reconfiguring at least one path of at least one IAB node of the wireless communication network based on the informing.

According to an embodiment, the re-routing is executed such that an existing service flows stay on a same path, whereas a previously established routes is switched over using a different path.

According to an embodiment, the method comprises: duplicating at least a part of the data traffic based on the degrading of the link in the first path; and transmitting the duplicated data traffic along different paths through the wireless communication network; or generating redundancy information for at least a part of the data traffic and transmitting the redundancy information along different paths through the wireless communication network.

According to an embodiment, duplicating or generating redundancy information relates to a PDCP (packet data convergence protocol) duplication; an duplication on RLC layer and/or a redundancy coding/mapping scheme e.g., using k-repetitions, fountain codes, network codes, cross interleaved packets, cross coded packets, any sort of packet duplication or message redundancy scheme.

According to an embodiment, duplicating the part of the data is provided by an integrated access and backhaul, IAB, node, e.g., by a radio link control, RLC, layer.

According to an embodiment, the duplicating is temporarily used to alleviate a short-term congestion along the first path.

According to an embodiment, transmitting the duplicated data traffic is done using soft resources of an integrated access and backhaul, IAB, node.

According to an embodiment, soft resources are resources, e.g., time-frequency-spatial resource, of an IAB node which are currently not used for other transmissions.

According to an embodiment, the second path is at least partly disjoint from the first path.

According to an embodiment, the first link and the second link are established as backhaul links or sidelinks, i.e., on the same hierarchy level; MT/DU of the wireless communication network.

According to an embodiment, the method comprises: operating the IAB node to availing of the second path and to timely inform other members such as IAB nodes of the change of the link characteristic; and/or taking action to re-route if the other side is able to handle the re-routing.

According to an embodiment, the method comprises: determining the change of the link characteristic; and requesting a node for re-routing the data traffic; and re-routing the data traffic accordingly.

According to an embodiment, the method comprises: detecting the change of the link characteristic; and informing another node of the wireless communication network about the change.

According to an embodiment, a method for operating a wireless communication network comprises: detecting a change of a link characteristic of an IAB-link of a path of the wireless communication network; and informing another node of the wireless communication network about the change.

According to an embodiment, the method comprises:
using multi connectivity of an IAB node to establish, with the IAB node, a first link for a first path to a network node of the wireless communication network and a second link for a second path to a network node of the wireless communication network;
routing a data traffic of the IAB node via the first path; and
re-routing at least a part of the data traffic over the second path in case of the past, present or expected change of the link characteristic of a link of a path of the wireless communication network.

According to an embodiment, a computer readable digital storage medium is provided, having stored thereon a computer program having a program code for performing, when running on a computer, a method according to one of previous claims.

According to an embodiment, an IAB node is provided, configured for operating a wireless communication network, the IAB node comprising a wireless interface and configured for:
using multi connectivity of an IAB node to establish, with the IAB node, a first link for a first path to a network node of the wireless communication network and a second link for a second path to a network node of the wireless communication network;
routing a data traffic of the IAB node via the first path;
re-routing at least a part of the data traffic over the second path in case of a past, present or expected change of a link characteristic of a link of a path of the wireless communication network.

According to an embodiment, a network node is provided, configured for operating in a wireless communication network, the network node comprising a wireless interface and configured for: detecting a change of a link characteristic of an IAB-link of a path of the wireless communication network; and informing another node of the wireless communication network about the change.

According to an embodiment, the network node is an IAB node or a user equipment, UE.

To address the above described issues, solutions propose to aim at utilising MR-DC/NR DC to improve shortcomings in backhaul IAB networks for the cases of:
1. Congestion and latency on any of the backhaul links on one of the branches,
2. Radio Link Failure (RLF) on one of the MCG or SCG links.

Note that high congestion could lead to RLF, thus mechanism described below for congestion mitigation may also be reused in case of RLF.

Some embodiments are described In connection with dual connectivity. However, those embodiments are not limited to have capabilities to operate exactly two links simultaneously but are able for multi connectivity with at least two links simultaneously, e.g. at least two, at least three, at least five or even more.

With regards to the term path In a wireless communication network and/or a link therein, embodiments may relate to a path to possibly mean an aggregation of parallel links, i.e., multiple links in parallel, e.g., using different carriers or frequency bands, between two nodes and/or a concatenation of links one after another, e.g., using multiple hops between more than two nodes. A route may thus relate to a concatenation of hops, while one hop (e.g., a stage between one MT to the next DU) may contain one or multiple links to be used. Therefore, a particular packet can travel a different route/path like another packet. Further, a path may also contain a single hop and In case of multi connectivity, multiple carriers may be used as separate links. That is, when referring to switch a path such a scenario or to re-route data traffic from a first path to a second path, the data traffic may be re-routed from a first carrier of the first link to a second carrier of the second link even if the two involved nodes stay the same.

### Congestion Mitigation

In a multi-hop IAB network, congestion can occur on any of the backhaul links along the path. In the case of dual-connected IAB node, which has at least two paths towards CU(s), in case of congestion on one of the paths, the IAB node may benefit from coordination of flows between the paths.

In one embodiment, the uncongested path takes over some of the data traffic: For example, in case there is a persistent congestion on a link (path) over a certain period, reported to the CU by the IAB-nodes along the path, the CU can pre-configure/configure the other path to take over some of the backhaul traffic. For this, the existing hop-by-hop (h2h) mechanism can be used. Nevertheless, this rerouting may introduce additional delays, in case the number of hops is increased. Thus, the number of hops shall be considered, e.g., by counting the number of hops from the IAB-DU node, such that the hop count for rerouting is minimized. Note that an increased number of hops will add delay to the data traffic which might hurt the QoS requirement for a given data service/flow. Furthermore, there may be a minimum or maximum number of allowed additional hops, which may be tolerated on a new route, e.g., min_{hops_onroute} {route_{old}, route_{new}}≤hopsₘₐₓ, with hopsₘₐₓ=1. In case this rule is violated, according to an embodiment, an IAB-DU or the CU would have to reroute via a completely different path, in order to fulfill the service requirement. Note, that local rerouting by the IAB-DU itself may reduce control traffic within the IAB backhaul network and may be configured or pre-configured, by any node, e.g., even by a CU or by a DU or by another entity belonging to the core network (CN), e.g., a network function (NF). Thus, local rerouting in case of a temporary congestion may be much faster than setting up new paths via the CU.

For using an improved link or path, the number of hops may also decrease. Alternatively or in addition, a larger number of hops may increase or also decrease the latency/delay. Embodiments may relate to a choice about the path and/or about a decision whether to re-route at least a part of the data traffic in order to fulfill at least one of the following constraints:
1) Not to exceed/go below a predefined number of hops,
2) Not to exceed/go below a predefined route length/delay/latency,
3) Not to exceed/go below a certain capacity provisioning,
4) Not to exceed certain concatenated outage probability,
5) Not to violate a predefined service level (with certain probability))).

According to embodiments, a targeted service level (throughput, delay, or a combination of such normalized parameters etc.) may have to be achieved and the selection of the second path alone or together with at least the first path will allow to satisfy the predefined overall service level. For example, mapping of traffic using multiple paths/routes together may achieve e.g. a higher reliability vs. throughput tradeoff than each individual path could provide. That is, the part of the data traffic is re-routed via the second path; and at least a part of a remaining data traffic is routed via the first path; wherein the second path is selected to provide the requested service level commonly with the first path. Alternatively, e.g., when routing the complete data traffic of the IAB node via the second path, then the second path itself may provide for the requested QoS, e.g., if the new route is selected to be within a certain service level, possibly within +/−a threshold. Of importance may be the lower level, so that the new route can achieve at least a certain QoS.

Uncongested path takes over some traffic and new route (local decision/rerouting or preconfigured by the CU): Furthermore, some of the nodes along the uncongested path can be preconfigured/configured by the CU to perform re-routing in case their links start experiencing congestion due to the additional load.

(Short-term congestion)/Trigger: For example, on the DL, each IAB-node (the DU-part), upon reception of a single, or multiple flow-control indications from a child note (SoTA) within a specified period, can be pre-configured to re-route some of the packets using e.g. local re-routing. Local re-routing may only, for example, point to a next hop, or to a path segment that will bypass the congested link. It may be that only some IAB nodes along the path are designated to perform local re-routing.

Longer-term action/Trigger: If congestion persists, i.e. flow control indication is sent a number of times over a predefined threshold, the IAB-MT of the node experiencing congestion may report to the CU a congestion control info. Such information can contain the link ID, BH RLC channels that experience buffer overflow, the number of times the flow-control indication has been sent to the parent node, including granularity info etc. This indication is different from the one where parent IAB-DU informs of congestion the IAB-donor, using F1AP gNB-DU Status Indication procedure. According to this embodiment, the receiver (IAB-MT) can directly inform the IAB-donor of the unresolved (persistent) congestion. This enables the IAB-donor to perform balancing/re-mapping of QoS flows between the two paths. The IAB donor may also initiate the entire path-switch. The path-switch also includes a procedure of changing, e.g. SCG or modifying MCG. If MCG and SCG (Parent 1 and Parent 2) belong to different donors, the donors (CU-CPs) can exchange the information on congestion, number of hops on the respective paths, available capacity and the like. This would enable IAB-donor 1 (of MCG) to either perform balancing/re-mapping of QoS flows or to initiate a path-switch for the SCG path.

On the UL, based on a predefined threshold on a e.g. a number of scheduling requests, or based on buffer status reports of child nodes/UEs and/or their pre-emptive buffer status reports, the node (e.g. its IAB-MT) may be pre-configured to perform local re-routing of the BH traffic. The re-routing may use the second path, if capacity and other service parameters permit. If congestion on the node persists (e.g. F1AP gNB-DU Status Indication may be a procedure to trigger an action by the IAB-donor CU), the CU may then request an entire path switch, which also uses a change of SCG or MCG modification. Such Information or such a signal may also be sent by a UE in addition or as an alternative, e.g., in case the UE is in multi-connectivity mode, since a UE might then observe/measure different behavior on the multiple paths, but it is not transparent if that is a problem on the access link itself or in the backhaul network. The UE might observe that the access link is fine, but still the traffic over this link and the associated path degrades somehow.

Embodiments may base on the finding that for the case of a degraded link, a use of dual connectivity or multi connectivity allows that the congestion or link failure is possibly in only one of the partial routes/paths and that, following this assumption is likely that the “other” path available to send a message to the corresponding node or the failed/congested link. This allows to mutually or unidirectionally informing the other end of a particular link, that a decision about re-routing has been made. Furthermore, additional new configurations can be exchanged, e.g. establishing a third link replacing the malfunctioning one. Such a re-routing may be performed locally and/or in a centralized manner. For the example of an at least partly centralized decision, e.g., at a CU, the CU may re-route the more than just the data traffic of the IAB node, e.g. it may even stop carrier aggregation or dual connectivity, and just transmit data traffic of the IAB node and/or other nodes over a third route, which fulfills the entailed transmission criteria, e.g., capacity and/or delay. So the degradation in one of the routes may trigger the CU to check for newly available routes to perform reconfiguration of IAB nodes.

The CU can decide, based on the capacity of the links between the hops and congestion persistence (e.g., duration, reports on transmissions exceeding some predefined threshold, delay, the number of denied scheduling requests etc.), which IAB nodes can perform either branching out based on pre-configured backup routes or local re-routing.

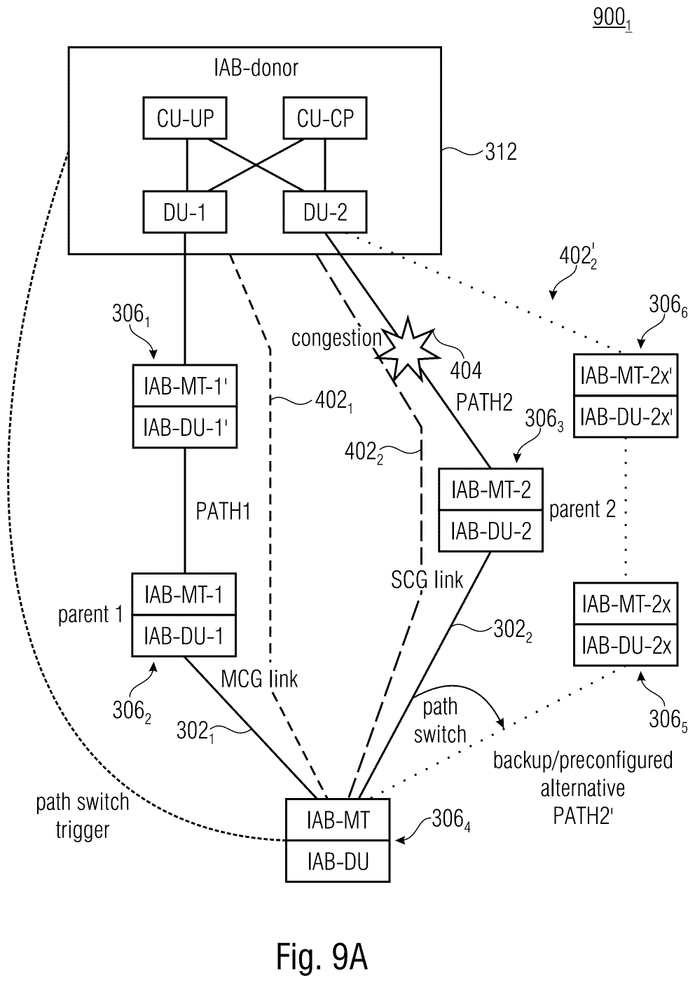

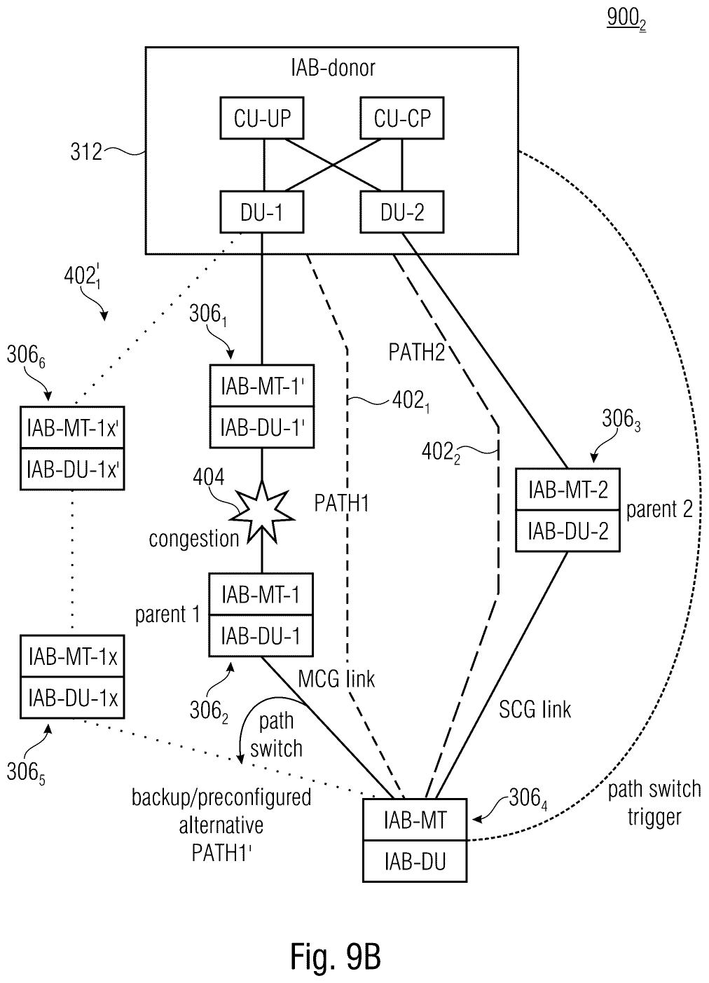

FIGS. 9A-B show schematic block diagrams of a solution to address a congested path, e.g., a Congestion-triggered path-switch. FIG. 9A shows an example by way of a schematic diagram of a at least a part of a wireless communication network 900₁ having a congested path 402₂ indicated as PATH2, e.g., based on a disturbance or congestion 404 between IAB node 306₃ and the IAB donor 312. In this embodiment, the traffic may be rerouted via a path 402₁ indicated as PATH1, or alternatively, a new connection is setup via a path 402′ comprising IAB nodes 306₅ and 306₆ indicated as IAB-MT-2x2x/IAB-DU-2x and IAB-MT-2x/IAB-DU-2x. Note, the alternative route 402′₂ adds an additional hop to the data stream in the FIG. 8A.

FIG. 9B shows a schematic diagram of at least a part of a wireless communication network 900₂ according to an embodiment where path 402₁ comprises the congestion 404 to make path 402₁ inoperable. In FIG. 9B the path switch from path 402₁ to alternative path 402′₁ having a similar configuration when compared to path 402′₂ of FIG. 9A, may yields a comparable latency constraint since data traffic is routed via a dual-hop BH network when circumventing 2 IAB nodes 306₁ and 306₂ of path 402.

In addition to this, depending on the congestion status, the IAB node 306₃ marked as IAB-node-2 may also perform CP/UP-splitting and just reroute the data traffic which is suffering from the congestion. In case that the capacity is cause of the congestion on 402₂/PATH2, it may help to reroute just the data plane via a different IAB node, in case of delay congestion, it may be more important to reroute the control plane via a different IAB node. In all cases, the CU/IAB-donor may be informed about the change. Alternatively or in addition, the traffic may be split up based on priority, cast type (unicast, groupcast, broadcast). Priority may be evaluated, for example, based on costs or backhaul channel QoS mapping or a backhaul channel ID and/or using a backhaul, BH, Radio link control, RLC, channel being an RLC channel between two nodes, which is used to transport backhaul packets. A BH channel ID may indicate an identifier of such a backhaul channel. Furthermore, the IAB node may decide to reroute certain traffic via a different route. The criteria may also be that existing service flows stay on the same route, whereas previously established routes are switched over using a different path.

For the splitting, for example, control plane, CP, data may be separated or split from user plane, UP, data by routing the CP over one link while the UP is transmitted via the second link only. According to embodiments, this may relate to parts of the CP or UP data or for the complete CP or UP data. E.g., even parts of the CP and/or parts of the UP can be rerouted exclusively and/or split up themselves. For example, a part of the CP traffic may be split over two links while UP traffic goes over just one of the links or vice versa. Any other combination is possible.

According to embodiments, for redundancy reasons, redundancy coding/mapping schemes (e.g., k-repetitions, fountain codes, network codes, cross interleaved packets, cross coded packets, any sort of packet duplication or message redundancy scheme) may be applied using the two links and the resulting two partial routes/paths, e.g., using data duplication or the like. Alternatively or In addition, a PDCP duplication may be used on the downlink, DL, or uplink, UL, or sidelink, SL, e.g., by the IAB-donor to send the same data along the two paths. The duplication may be a constant or a temporary measure, e.g., switched on to alleviate short-term congestion.

Service parameter definition and appropriate routing: Considering potentially different path-lengths and/or aggregate capacity along the two paths, the traffic can be routed according to the considered service parameter (reported by the all IAB-MTs, but configured by the CU). Service parameters can be a QoS measure, e.g., delay, capacity, jitter, or a combination of such normalized parameters.

Furthermore, in case of a temporary congestion, the IAB-DU may trigger a duplication to be performed, so that the probability of a successful reception by the UE is increased. The benefit of this embodiment is that it can be easily configured by the IAB-donor/CU, which sets up an additional route and performs data duplication on the PDCP layer for this data stream. Furthermore, the IAB backhaul node may have the possibility to send a control message to the CU, in case the congestion status changes, so that this data duplication can be disabled quickly, e.g., in case the congestion is fixed.

In current NR releases, redundancy transmission using data duplication is performed on the PDCP layer. Nevertheless, in case of IAB backhaul network optimization, data duplication may be done on the RLC layer and within IAB nodes, e.g., on IAB DUs, if an additional path over another IAB node can be configured. Also, if resources are available in the DU downstream direction, e.g., so-called soft-DU resources may be used to allocate duplicate packets, to increase transmit diversity. Note in this context, soft-DU resources are radio resource which are available at a DU in downstream direction, but which are currently not used by any other transmission.

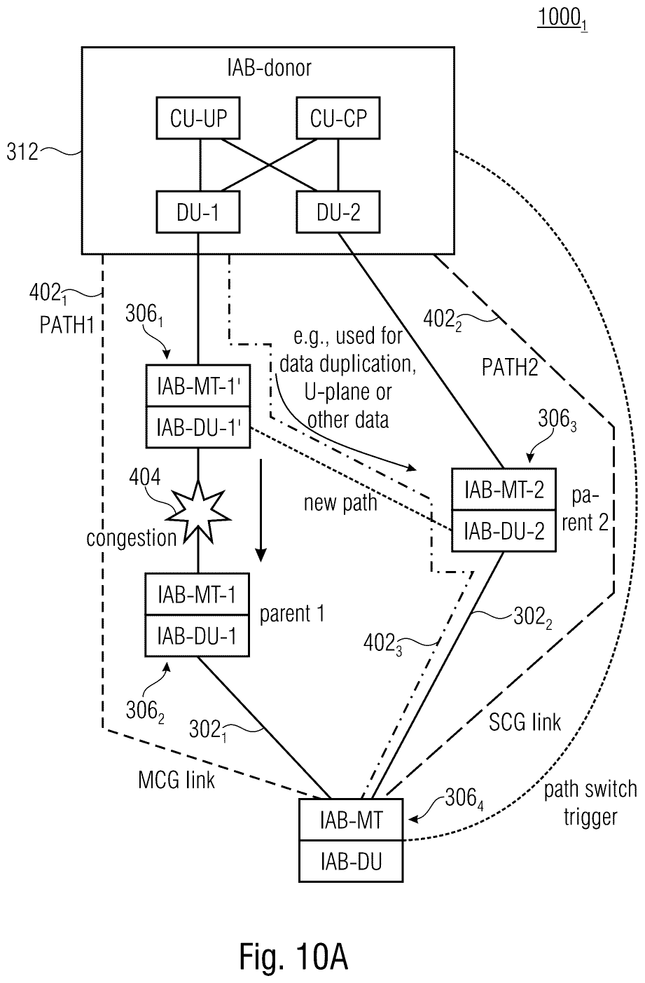

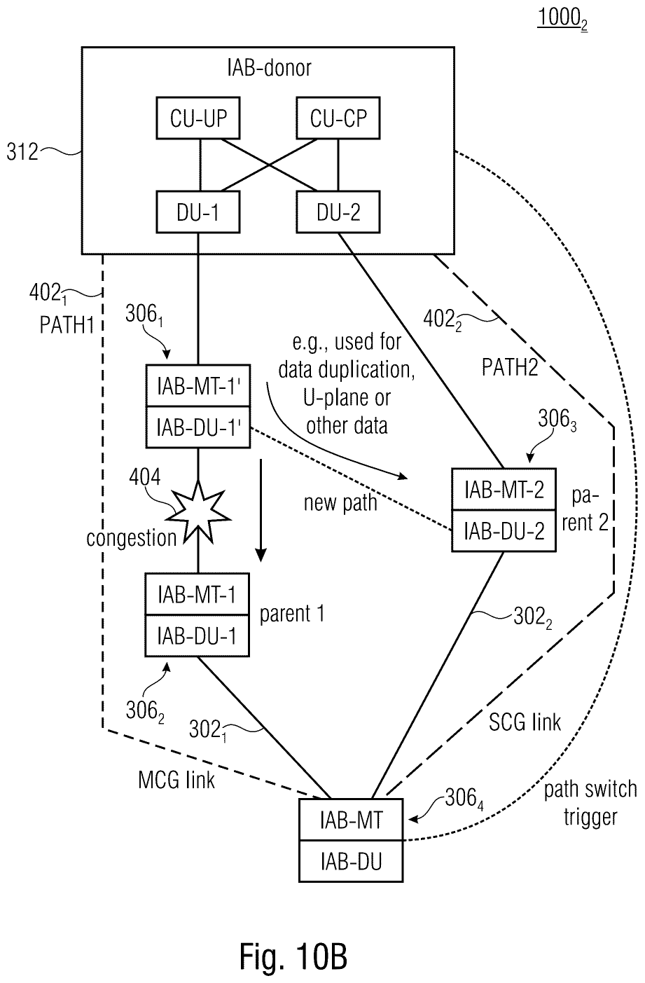

As an alternative or in addition, a path switch can also be done within the second hierarchy of an IAB backhaul network. For example, whilst making reference to FIG. 10A and FIG. 10B, if a connection is detected on PATH1 402₁, the IAB-DU 1′ of IAB node 306₁ may connect to the IAB-DU-2 of IAB node 306₃ as shown in FIG. 10A and/or it may connect to IAB-MT-1 of IAB node 306₃ as shown in FIG. 10B. Hence, re-routing can be performed between the DUs and/or between MT and DU of the respective IAB nodes. FIG. 10A and FIG. 10B show Congestion triggered path switches within IAB parent node in a wireless communication scenario 1000₁, 1000₂ respectively.

The new path 402₃ can be used for UP, CP and/or redundancy transmission as in data duplication. Note that this path can be preconfigured or configured temporarily or permanently, depending on the traffic requirement within the backhaul network. Furthermore, this route can also be activated based on feedback receive from IAB-MT 1 of IAB node 306₂, e.g., depending on HARQ NACKs, if a congestion is detected, the IAB-DU-1′ of IAB node 306₁ may trigger to add the new path 403₃. On the contrary, if the congestion statistics show that PATH1 402₁ can fulfil the service requirements, the new path 402₃ may be disconnected.

### Radio Link Failure/MCG/SCG Failure

In known systems also referred to as state-of-the-art, SOTA, the link failure recovery from an IAB-node towards MN or SN is dealt with separately. Considering, however, that the backhaul links carry traffic from a number of UEs, embodiments address the effect that a loss of a one of the paths has a detrimental impact on all devices whose traffic is carried over that link.

However, embodiments are not limited to backhaul links established between nodes along a branch between an access node and a CU. For example, embodiments may also relate other types of links such as a sidelink, also referred to as device-to-device (D2D) link, between two nodes on the same hierarchical level or two parts of a node at a same or similar level. Embodiments thus relate to any kind of path diversification and/or meshing. A sidelink may, for example, relate to a connection direct connection between a mobile termination, MT, and another MT; or MT and directly to a UE. The sidelink refers to the sidelink specified in NR which may use the PC5 interface between links. In the context of IAB, a sidelink between MTs currently does not exist and may be specified under a different term. Nevertheless, this sidelink may implement the functionality specified for the NR sidelink, which is mostly specified in the context of vehicular-to-vehicular (V2X) communications.

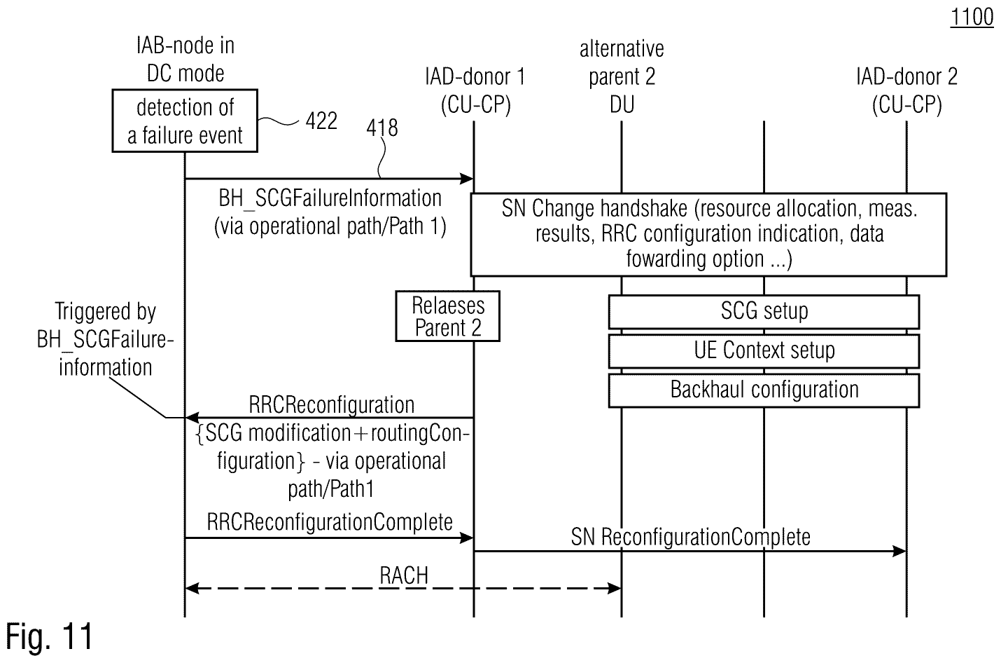

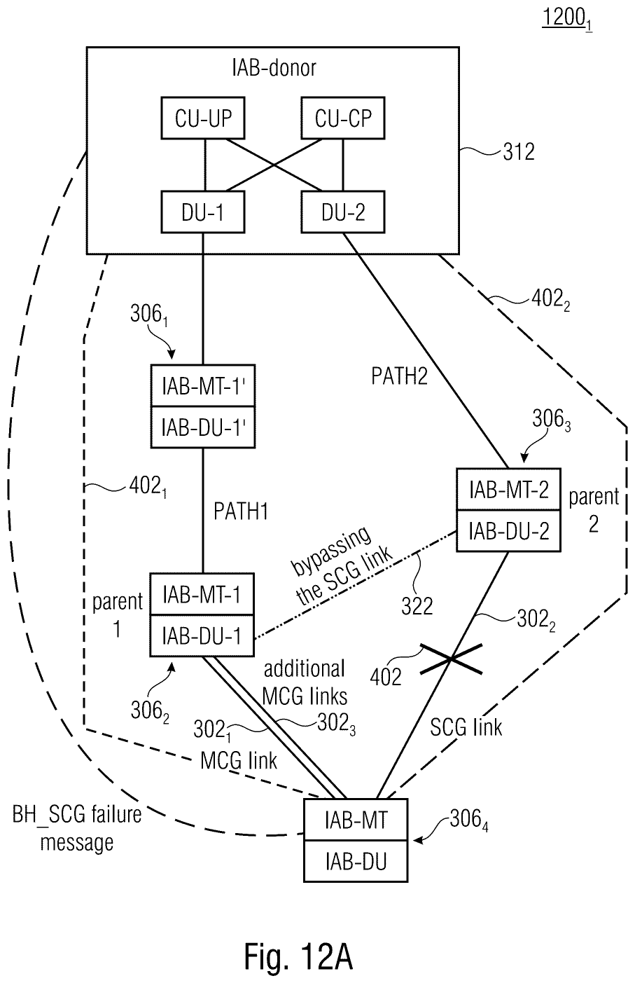

FIG. 11 shows a schematic signalling flow chart of nodes implementing a method 1100 according to an embodiment. The signalling is between an IAB node and a two donors referred to as parent 1 and parent 2 as, e.g., implemented in the network of FIG. 8B. Note that a use of an alternative parent is optional, e.g., in an optional multi-hop-communication as is the use of an (intermediate) parent towards the donor. For example, an IAB node in DC mode such as IAB node 306₄ in networks 900₁, 900₂, 10000₁ and/or 1000₂ may have connections or links 302₁ and 302₂ to parent IAB nodes 306₂, 306₃ respectively, e.g., their DUs that are adapted to forward traffic to a single or more than one IAB donors 312. In FIG. 11, BH_SCGFailure notification may trigger a change of the parent node, wherein the old parent node is not shown for brevity.

In another embodiment, that may be combined with other teaching described herein, the operational branch used to provide an extended failure notification and trigger actions by MCG: in case of RLF on SCG or a notification on RLF further up the SCG branch, the other operational branch can be used to provide an extended backhaul failure notification BH_SCGFailureInformation 418, which can trigger an action by MCG. According to an embodiment, an extended failure notification may include:
IAB-MT SCG RLF detection 422 and its cause, e.g., out-of-sync timer expiry, random access problem indication from MAC, indication from RLC that the maximum number of retransmissions has been reached, etc.
Notification on the failure of RLF recovery from further up the SCG branch, including the number of hops the affected node is away from the IAB-node or SCG/SN node,
Notification on the RLF detection from the affected upstream node after a period has elapsed but before the downstream RLF failure recovery notification is sent.

The notification may alternatively or in addition include measurement results as in SCGFailure measurement results (SOTA), including, according to embodiments, sorting the best neighbor cells according to the specified metric, e.g., RSRP, RSRQ, SINR.

Any of the above notifications or combinations thereof may be used to trigger an action by the MCG. Actions can include RRC-based commands for SCG modifications, or the addition of another parent (SN) and/or release of the existing parent (SN). Furthermore, the command may include routing configuration, which may be a simple indication of the already preconfigured route ID, or a new routing configuration.

MCG adds SCells and bypasses the SCG parent: This embodiment, combinable with other solutions without limitation, relates to one of the possible actions in case any of the events described above occurs. The MCG can then be modified to include additional Secondary Cells (SCells). Hence, BH_SCGFailure information can include a notification on SCG failure detection by IAB-MT or RRCReestablisment failure towards SCG, as discussed above. Upon reception of the BH_SCGFailure indication, the MCG branch can be configured to re-route the additional traffic onto the remaining route.

That is, failure of secondary link 302₂ may be compensated at least in parts by adding additional links master 302₃ in parallel to the link 302₁, wherein a failure in link 302₁ may be compensated accordingly by additional links parallel to secondary link 302₂. This does not preclude to use additional paths as shown in FIGS. 9A-B for further compensation of lost traffic capacity.

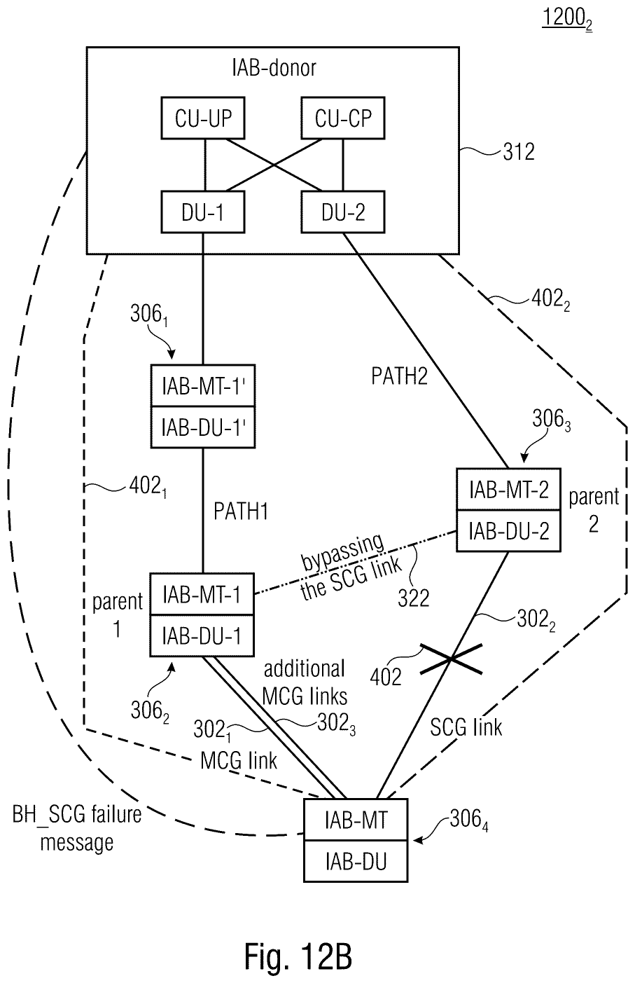

Addition of MCG links and bypassing via the SCG link can be performed using re-routing between the DUs or between MT and DU, as shown in FIGS. 12A-B. Therein, such a scenario of wireless communication networks 1200₁ and 1200₂ according to embodiments is shown, whereby the IAB-node 306₂ (IAB-DU-1) node may be pre-configured to perform re-routing towards IAB-DU-2 306₂ after a period of time has elapsed or after a failure of RRC Reestablishment towards SCG as shown in FIG. 12A. Alternatively, or in addition the IAB node 306₂ can be preconfigured to re-route the traffic from IAB-MT-1 towards IAB-DU-2 of IAB node 306₃ as shown in FIG. 12B. Alternatively or in addition, the IAB-donor CU (CU-CP) of IAB donor 312 may signal to Parent 1/MCG 306₂ which at least one other route has the available capacity to carry the traffic from SCell links. Both may result in a link 322 between IAB nodes 306₂ and 306₃ bypassing the link 302₂ that is possibly blocked by congestion 402.

For example, the IAB-donor CU of IAB donor 312 may calculate the available capacity along different paths by polling IAB nodes, using the existing F1AP procedure on resource status reporting between the CU and every IAB-DU. This procedure may be used at by a gNB-CU to request the reporting of load measurements to gNB-DU (TS 38.473, v16.02, sections 8.2.10 and 8.211). The Composite Available Capacity IE indicates the overall available resource level in the cell in either DL or UL (TS 38.423 v16.02, section 9.2.2.52). When starting a measurement, the Report Characteristics IE in the RESOURCE STATUS REQUEST indicates the type of objects gNB-DU shall perform measurements on.

Alternatively or in addition, one, more or each IAB node may be configured to provide available capacity information to the IAB-donor for upstream and downstream, separately.

CU notification on a link failure using the operational branch: In case of a backhaul link failure on any of the links above the parent nodes on either of the paths, a notification can be sent downstream until it reaches the dual-connected IAB node 306₄. The notification can refer to, e.g., BH RLF, RLF recovery failure, RLF recovery success. The operational path can then provide the appropriate notification to the CU, using BH_SCGfailure message. A modified BH RLF indication PDU can be used for indication of RLF, RLF recovery failure, RLF recovery success to the previous failure, including the number of hops from the dual-connected IAB.

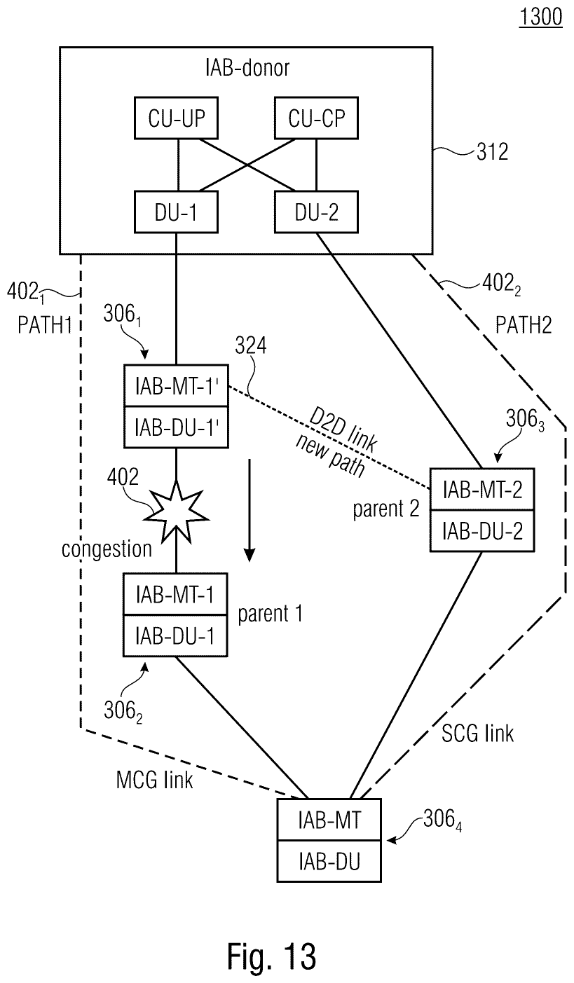

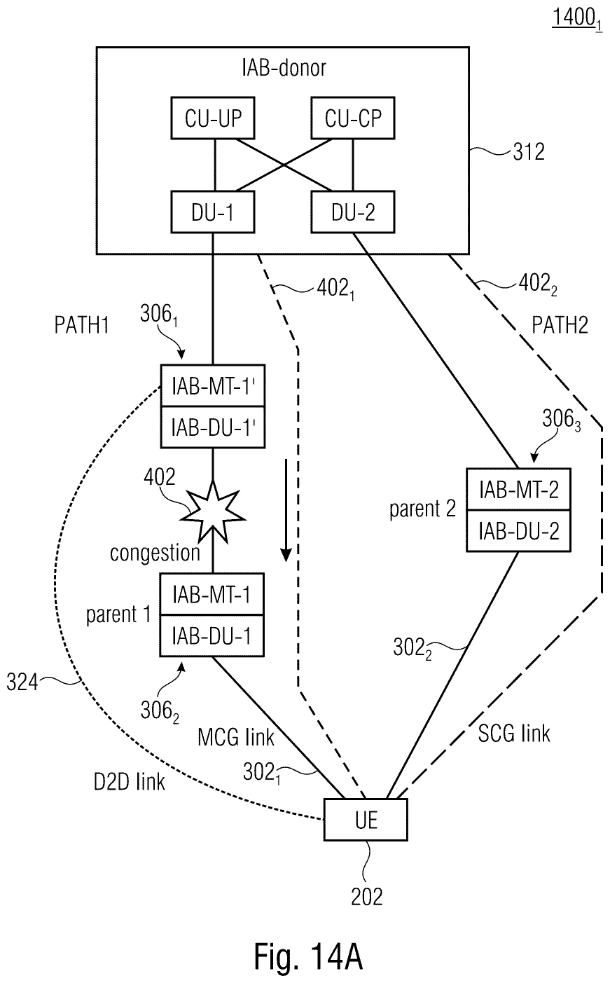

FIG. 13 shows a schematic block diagram of a wireless communication network 1300 according to an embodiment in which IAB nodes 306₁ and 306₃ may establish a D2D connection or D2D link 324 between them to bypass congestion 402 between IAB nodes 306₁ and 306₂ that disables path 402₁. The new connection 324 may comprise a direct link between the two MT parts of the respective IAB nodes utilizing NR sidelink features.

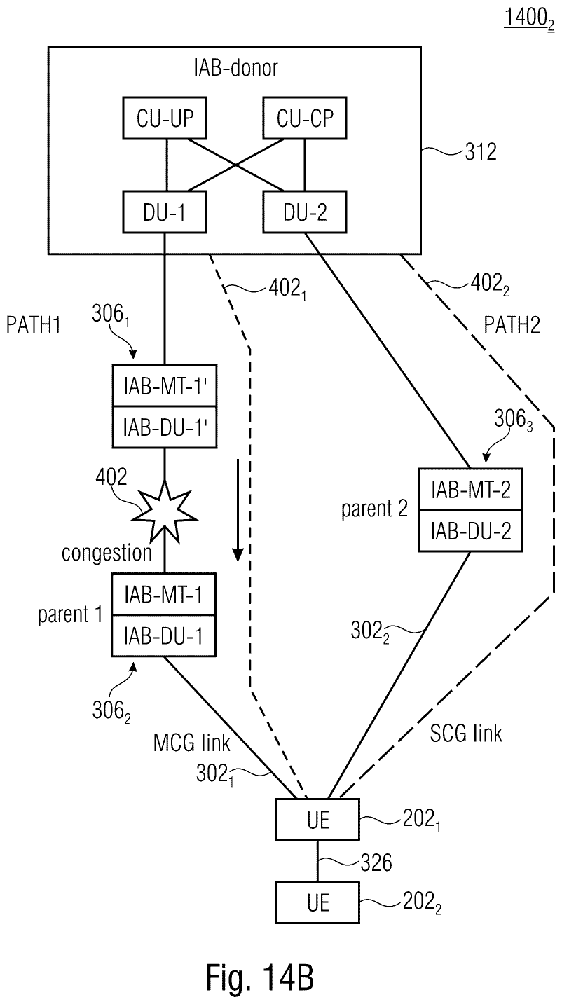

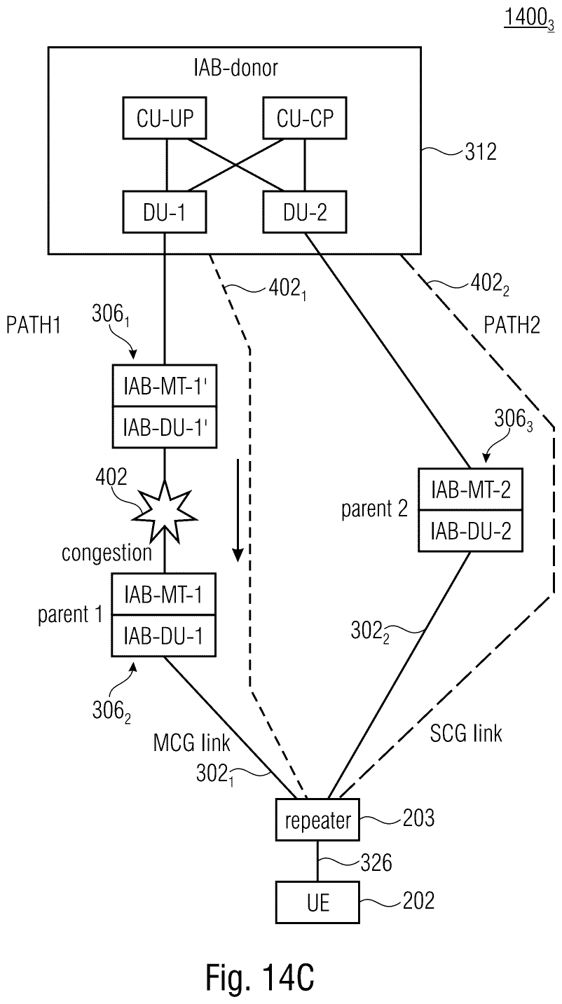

FIG. 14A shows a schematic block diagram of a wireless communication network 1400₁ according to an embodiment in which the UE 202 access link is used to re-route the traffic and avoid congestion, i.e., the D2D link 324 may directly bridge a part of path 402₁.

The new connection 324 may comprise or be a direct link between the MT part if an IAB node 306₁ and a UE 202 utilizing the sidelink, e.g., via PC5, as specified in NR.

In a further embodiment, the IAB node 306₁ may be mobile as in mobile IAB (mIAB), e.g., placed inside of a car or a bus, and the UE can connect via Uu to a gNB or to a IAB-DU, which is then connected to a CU. The UE 202 would also allow for direct communication as in NR sidelink via PC5.

FIG. 14B shows a schematic block diagram of a wireless communication network 1400₂ according to an embodiment in which, when compared to wireless communication network 1400₁ the UE 202 is represented as UE 202₁ to which at least one further UE 202₂ has established a link 326 that may comprise, for example, D2D link 324, a PC5 link and/or other types of links such as WiFi® and/or Bluetooth®. UE 202₁ thereby provides for an access link for UE 202₂ and may be considered as an IAB node or mobile IAB node. The IAB node may provide for an access to the backhaul, e.g., within a single hop. UE 202₁ may operate, for example, using dual-connectivity or multi-connectivity, e.g., using a multi-sim configuration. Furthermore, also UE 202₁ may operate as a mobile IAB node, e.g., may be placed inside of a vehicle, and may provide connectivity to another UE, e.g., UE 202₂, or set of UEs.

FIG. 14C shows a schematic block diagram of a wireless communication network 1400₃ according to an embodiment in which, when compared to wireless communication network 1400₂ a repeater 203 is arranged instead of UE 202₁. However, this does not preclude to have additional UEs in wireless communication network 1400₃. The repeater may be configured to operate according to control signals received from the wireless communication network 1400₃, i.e., it may be a network controlled repeater. Alternatively or in addition, the repeater 203 may be a repeater with reduced capabilities, i.e., a RedCap repeater. UE 202 may establish a link 326 to the repeater 203, the repeater 203 thereby operating as an IAB node. Note, also the repeater and/or UE 202 may operate as mobile IAB nodes, e.g., may be placed inside of a vehicle and may provide connectivity to one or more further UEs.

Although relating to a degradation in a link or a path, embodiments also relate to improvements such as
decrease in data rate/throughput,
increase in packet delay or jitter,
packet loss, e.g., by an increase in HARQ NACKs received by a IAB node/DU
decreased RSSI, RSRP, SNR, SINR, PMI, rank (RI) of the link measured at the IAB node,
carrier frequency offset (CFO) is above a predefined threshold, or synchronization loss, radio link failure (RLF),
costs, e.g., defined as a combination of different KPIs, e.g., delay, throughput, etc.
Newly available links in the wireless communication network

Such improvements may be measured according to embodiments as well as degradations. Based on an improvement, for example, there may be determined that an old or currently used link or path, e.g., at least a link of a first path of an IAB node is not necessary anymore and/or that a different path is more suitable. Data traffic may be re-routed at least temporarily over the second link and/or a newly established link. New links to be established may occur, e.g., in changing radio propagation environments, e.g., in case of moving objects and/or nodes. That is, a re-routing may be based on degradation and/or improvements in network paths and/or in case a key performance indicator KPI or characteristic with respect to the link over a second path changes, whereas changes can imply, e.g., degradation or improvement. For example, the old path is not required anymore.

Although relating to a change, e.g., a degradation, an improvement, a termination or a new availability, of a link (and as the link is part of a path also a change of the path), the change is not necessarily in the past but may also be currently happening or in process to be determined, measured, detected or elsewise recognised. Further, e.g., by probing or the like, the change may also be expected and, thus, in the future. In general, the change may relate to a changed link and/or path performance.

Embodiments relate to re-route at least a part of data traffic. Such embodiments may also relate to announcing of the re-routing such that the other side may prepare for the re-routing. Alternatively or in addiction, the other side, i.e., affected nodes, may also feedback, if they can handle the re-routing. To perform or implement the re-routing may be based or depend on such feedback. E.g., in case of a negative feedback, the re-routing may be skipped or an alternative path may be searched. That is, operating the IAB node to availing of the second path and to timely (i.e., to allow for sufficient time for reaction) inform a central unit of the wireless communication network, CU, or other members such as IAB nodes of the change of the link characteristic; and/or taking action to re-route if the other side is able to handle the re-routing.

Alternatively or in addition, embodiments may relate to an IAB node availing of the second path to 1) (timely) inform the CU, the IAB node or another node of the degradation it experiences 2) requesting an action 3) taking action to re-route.

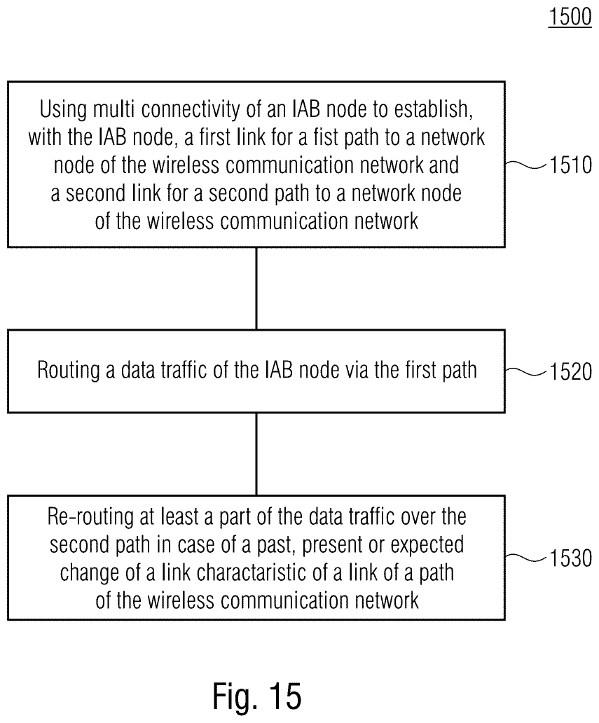

FIG. 15 shows a schematic flow chart of a method 1500 according to an embodiment. The method may be used for operating a wireless communication network. The method comprises a step 1510 of using multi connectivity of an IAB node to establish, with the IAB node, a first link for a first path to a network node of the wireless communication network and a second link for a second path to a network node of the wireless communication network. The method comprises a step 1520 of routing a data traffic of the IAB node via the first path, e.g., to the IAB node or from the IAB node; A step 1530 comprises re-routing at least a part of the data traffic over the second path in case of a past, present or expected change of a link characteristic of a link of a path of the wireless communication network.

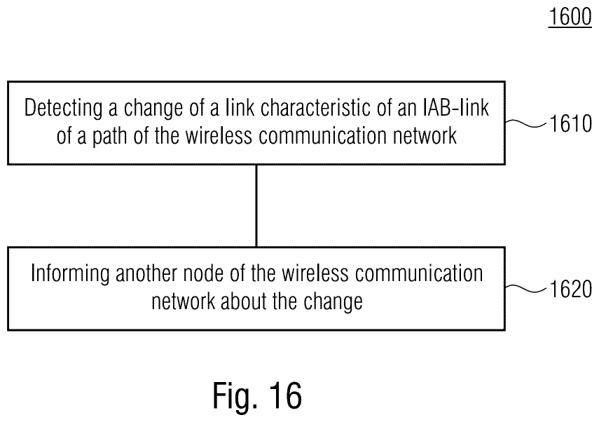

FIG. 16 shows a schematic flow chart of a method 1600 according to an embodiment. Whilst method 1500 focuses on re-routing method 1600 may also be used for operating a wireless communication network but focuses, by using a same background on detecting a change of a link characteristic of an IAB-link of a path of the wireless communication network in a step 1610; and informing another node of the wireless communication network about the change in a step 1620. Both methods 1500 and 1600 may be used together or separately. Whilst method 1500 aims to restore traffic flow, method 1600 aims to inform others about the change, i.e., a link failure or a restoration of a link, a temporal or permanent increase in quality or degradation of the link or the like.

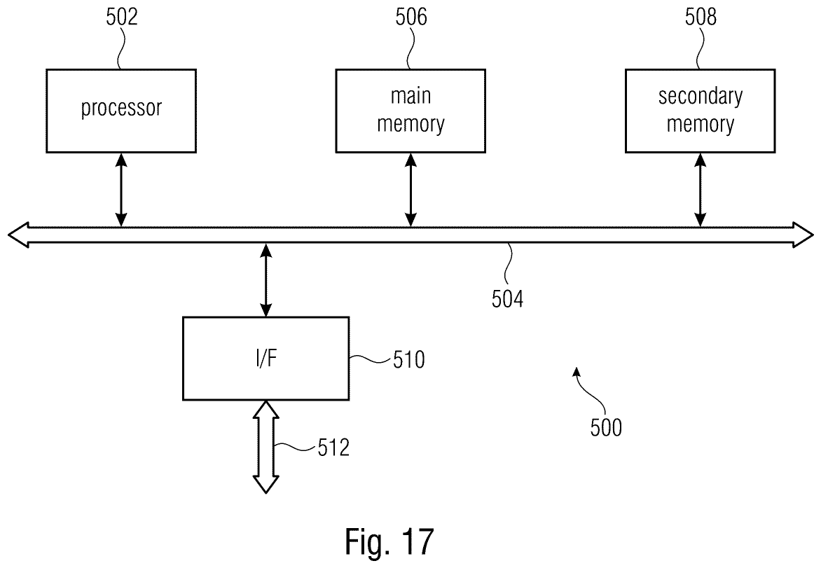

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 17 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from of electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### Abbreviations

3GPP third generation partnership project
ACK acknowledgement
AIM assistance information message
AMF access and mobility management function
BS base station
BWP bandwidth part
CA carrier aggregation
CC component carrier
CBG code block group
CBR channel busy ratio
CQI channel quality indicator
CSI-RS channel state information-reference signal
CN core network
D2D device-to-device
DAI downlink assignment index
DCI downlink control information
DL downlink
DRX discontinuous reception
FFT fast Fourier transform
FR1 frequency range one
FR2 frequency range two
GMLC gateway mobile location center
gNB evolved node B (NR base station)/next generation node B base station
GSCN global synchronization channel number
HARQ hybrid automatic repeat request
ICS initial cell search
IoT internet of things
LCS location services
LMF location management function
LPP LTE positioning protocol
LTE long-term evolution
MAC medium access control
MCR minimum communication range
MCS modulation and coding scheme
MIB master information block
NACK negative acknowledgement
NB node B
NES network energy saving
NR new radio
NTN non-terrestrial network
NW network
OFDM orthogonal frequency-division multiplexing
OFDMA orthogonal frequency-division multiple access
PBCH physical broadcast channel
P-UE pedestrian UE; not limited to pedestrian UE, but represents any UE with a need to save power, e.g., electrical cars, cyclists,
PC5 interface using the sidelink channel for D2D communication
PDCCH physical downlink control channel
PDSCH physical downlink shared channel
PLMN public land mobile network
PPP point-to-point protocol
PPP precise point positioning
PRACH physical random access channel
PRB physical resource block
PSFCH physical sidelink feedback channel
PSCCH physical sidelink control channel
PSSCH physical sidelink shared channel
PUCCH physical uplink control channel
PUSCH physical uplink shared channel
RAIM receiver autonomous integrity monitoring
RAN radio access networks
RAT radio access technology
RB resource block
RNTI radio network temporary identifier
RP resource pool
RRC radio resource control
RS reference symbols/signal
RTT round trip time
SBI service based interface
SCI sidelink control information
SI system information
SIB sidelink information block
SL sidelink
SPI system presence indicator
SSB synchronization signal block
SSR state space representations
TB transport block
TTI short transmission time interval
TDD time division duplex
TDOA time difference of arrival
TIR target integrity risk
TRP transmission reception point
TTA time-to-alert
TTI transmission time interval
UCI uplink control information
UE user equipment
UL uplink
UMTS universal mobile telecommunication system
V2x vehicle-to-everything
V2V vehicle-to-vehicle
V2I vehicle-to-infrastructure
V2P vehicle-to-pedestrian
V2N vehicle-to-network
V-UE vehicular UE
VRU vulnerable road user
WUS wake-up signal

1. A method for operating a wireless communication network, the method comprising:
using multi connectivity of an IAB or relay node to establish, with the IAB or relay node, a first link for a first path to a network node of the wireless communication network and a second link for a second path to a network node of the wireless communication network;
routing a data traffic of the IAB or relay node via the first path;
measuring a link characteristic by one or more of:
data rate/throughput,
packet delay or jitter,
packet loss
level of RSSI, RSRP, SNR, SINR, PMI, rank of the link measured at the IAB or relay node,
level carrier frequency offset is above a predefined threshold, or synchronization loss,
occurrence/probability/observation of radio link failure,
value or result of cost function or costs
amount/number of newly available links in the wireless communication network; and
re-routing at least a part of the data traffic over the second path in case of a past, present or expected change of the link characteristic of a link of a path of the wireless communication network.

2. The method of claim 1, wherein the re-routing of the at least part of the data traffic over the second path is based on the expected change of the link characteristic of the link of the path of the wireless communication network.

3. The method of claim 1, wherein the first path relates to an aggregation of parallel links between two nodes; or a concatenation of links over multiple hops.

4. The method of claim 1,
wherein the routed data traffic is routed from the IAB or relay node via the first path comprising the first link; and the re-routed data traffic is routed from the IAB or relay node via the different second path comprising the second link; or
wherein the routed data traffic is routed to the IAB or relay node via the first path comprising the first link; and the re-routed data traffic is routed to the IAB or relay node via the different second path or a part of the second path comprising the second link.

5. The method of claim 1, comprising:
operating the IAB or relay node to locally re-route the part of the data traffic based on a reception of a single, or multiple flow-control indications from a child node, e.g., for a short-term congestion.

6. The method of claim 1, comprising:
transmitting a congestion control information from the IAB or relay node or a device, e.g., a user equipment, served by the IAB or relay node to a central unit of the wireless communication network to indicate a persisting congestion;
re-routing the data traffic based on the congestion control information.

7. The method of claim 1, comprising:
for an uplink, UL, direction performing local re-routing of a backhaul, BH, traffic being part of the data traffic, based on a number of scheduling requests exceeding a predefined threshold or a buffer status report exceeding a predefined threshold.

8. The method of claim 1, wherein re-routing the data traffic comprises to transmit at least a part of the data traffic along the second path;
wherein re-routing the data traffic comprises to split a first part from a second part of the data traffic and transmitting the first part of the data traffic over the second link and not the second part.

9. The method of claim 8, wherein the first part is at least a part of a control plane related data in the data traffic and the second part comprises at least a part of a user plane related data in the data traffic; or
wherein the first part is at least a part of a user plane related data in the data traffic and the second part is comprises at least a part of a control plane related data in the data traffic.

10. The method of claim 8, comprising:
evaluating a priority of the data traffic, e.g., based on costs or backhaul channel QoS mapping or a backhaul channel ID; and
selecting the first part to comprise a higher priority when compared to the second part.

11. The method of claim 1, comprising:
configuring or pre-configuring at least one path node in the second path, e.g., using a central unit, CU, to perform re-routing or to instruct the IAB or relay node to perform rerouting in case a link of the path node experiences degradation, e.g., congestion or overload, due to the additional load caused by re-routing the data traffic.

12. The method of claim 1, comprising:
operating the IAB or relay node to locally re-route the part of the data traffic based on a reception of a single, or multiple flow-control indications from a child node, e.g., for a short-term congestion; and
informing the wireless communication network, e.g., a central unit, CU, and/or an IAB donor, about the re-routing.

13. The method of claim 1, comprising:
informing the wireless communication network, e.g., a central unit, CU, and/or an IAB donor about the change of the link characteristic; and
reconfiguring at least one path of at least one IAB or relay node of the wireless communication network based on the informing.

14. The method of claim 1, wherein the re-routing is executed such that an existing service flows stay on a same path, whereas a previously established routes is switched over using a different path.

15. The method of claim 1, comprising:
duplicating at least a part of the data traffic based on the degrading of the link in the first path; and transmitting the duplicated data traffic along different paths through the wireless communication network; or
generating redundancy information for at least a part of the data traffic and transmitting the redundancy information along different paths through the wireless communication network.

16. The method of claim 1, comprising:
determining the change of the link characteristic; and requesting a node for re-routing the data traffic; and re-routing the data traffic accordingly; or
detecting the change of the link characteristic; and informing another node of the wireless communication network about the change.

17. An IAB or relay node, configured for operating a wireless communication network, the IAB or relay node comprising a wireless interface and configured for:
using multi connectivity of an IAB or relay node to establish, with the IAB or relay node, a first link for a first path to a network node of the wireless communication network and a second link for a second path to a network node of the wireless communication network;
routing a data traffic of the IAB or relay node via the first path; and
re-routing at least a part of the data traffic over the second path in case of a past, present or expected change of a link characteristic of a link of a path of the wireless communication network.

18. A network node configured for operating in a wireless communication network, the network node comprising a wireless interface and configured for:
detecting a change of a link characteristic of an IAB-link of a path of the wireless communication network; and
informing another node of the wireless communication network about the change.

19. The network node of claim 18 being an IAB node, a relay node or a user equipment, UE.

20. The network node of claim 18, configured for:
using multi connectivity of an IAB or relay node to establish, with the IAB or relay node, a first link for a first path to a network node of the wireless communication network and a second link for a second path to a network node of the wireless communication network;
routing a data traffic of the IAB or relay node via the first path; and
re-routing at least a part of the data traffic over the second path in case of the past, present or expected change of the link characteristic of a link of a path of the wireless communication network.
